(19) United States
(12) Patent Application Publication
(10) Pub. No.: US 2018/0352715 A1
(43) Pub. Date: Dec. 13, 2018

(54) ATTACHABLE TILLING DEVICE

(71) Applicants: David Quillin, Grand Junction, CO (US); Tena Quillin, Grand Junction, CO (US)

(72) Inventors: David Quillin, Grand Junction, CO (US); Tena Quillin, Grand Junction, CO (US)

(21) Appl. No.: 15/926,340

(22) Filed: Mar. 20, 2018

Related U.S. Application Data
(60) Provisional application No. 62/517,574, filed on Jun. 9, 2017.

(51) Int. Cl. A01B 33/02; A01B 33/08

(52) U.S. Cl. CPC A01B 33/021; A01B 33/087; A01B 33/082

(57) ABSTRACT

An attachable tilling device for a vehicle is provided. The device includes a housing having a base member, wherein a pair of opposing side members extend downwardly from a first end and a second end thereof. A bar member is rotatably affixed between the pair of opposing side members, wherein the bar member rotates about a longitudinal axis. The bar member includes a plurality of tilling blades affixed thereto. A gear system is operably connected to the bar member, wherein the gear system rotates the bar member. A gearbox is disposed on an upper side of the housing, wherein a pair of shaft members are operably connected to the gearbox, wherein a first shaft member connects to the gear system and a second shaft member connects to a motor, such that when the motor is actuated, power is transferred to the gearbox, thereby rotating the plurality of tilling blades.

### CROSS REFERENCE TO RELATED APPLICATION

This application claims the benefit of U.S. Provisional Application No. 62/517,574 filed on Jun. 9, 2017. The above identified patent application is herein incorporated by reference in its entirety to provide continuity of disclosure.

### BACKGROUND OF THE INVENTION

The present invention relates to tilling machines used for farming. More specifically, the present invention provides a tilling device that removable secures to vehicle, such as, a tractor.

Many farmers provide irrigation channels in their fields in order to successfully grow crops. Traditionally, farmers use two types of tilling devices to create irrigation channels. The first device uses a broad rotational blade that results in grass and dirt falling into the freshly created irrigation channels, which diverts water to undesired locations. The second tilling device drags cutting blades through the ground, which leads to bunches of grass, dirt and debris falling back into the channel reducing the effectiveness of the irrigation channels, thereby resulting in significant crop loss. This results in inconvenience and excessive time and money investments for the user. Therefore, an attachable tiling device that prevents debris from falling into an irrigation channel and easily cuts through the ground is needed.

Devices have been disclosed in the known art that relate to tilling and raking devices. These include devices that have been patented and published in patent application publications. These devices generally relate to tilling and raking devices for farming or landscaping. Some devices include tilling blades that comprise a planar surface for tilling the ground for proper leveling. Another device includes a main frame that supports a plurality of tined members in combination with a pulverizer support roller for leveling the ground. Other devices utilize sets of teeth mounted on a rotatable cylinder in order to dethatch and pulverize the ground.

These known art devices have several drawbacks. Many of these devices lack a gearbox that transfers power from a vehicle to rotate a plurality of tilling blades, such that the tilling blades create uniformly spaced irrigation channels within the ground. Further, these devices fail to include a pair of opposing L-shaped blades that are uniformly disposed along a rotatable bar member. Lastly, these devices fail to disclose tilling blades that substantially remove dirt and debris from freshly created irrigation channels, such that water can effectively flow therethrough.

In light of the devices disclosed in the known art, it is submitted that the present invention substantially diverges in design elements from the known art and consequently it is clear that there is a need in the art for an improvement to existing tilling devices. In this regard the instant invention substantially fulfills these needs.

### SUMMARY OF THE INVENTION

In view of the foregoing disadvantages inherent in the known types of tilling devices now present in the known art, the present invention provides a new attachable tilling device for a vehicle wherein the same can be utilized for providing convenience for the user when creating irrigation channels for distributing water to crops in a uniform manner.

It is therefore an object of the present invention to provide a new and improved attachable tilling device that has all of the advantages of the known art and none of the disadvantages.

It is another object of the present invention to provide an attachable tilling device for creating clean even spaced and depth adjusted furrows which greatly improves the effectiveness of crease irrigation. The attachable tilling device includes a housing having a base member, wherein a pair of opposing side members extend downwardly from a first end and a second end thereof. A bar member is rotatably affixed between the pair of opposing side members, wherein the bar member rotates about a longitudinal axis. The bar member includes a plurality of tilling blades affixed thereto. A gear system is operably connected to the bar member, wherein the gear system is configured to rotate the bar member. A gearbox is disposed on an upper side of the housing, wherein a pair of shaft members are operably connected to the gearbox, wherein a first shaft member connects to the gear system and a second shaft member connects to a motor, such that when the motor is actuated, power is transferred to the gearbox, thereby rotating the plurality of tilling blades.

Another object of the present invention is to provide an attachable tilling device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the attachable tilling device.

FIG. 2 shows a front view of an embodiment of the attachable tilling device.

FIG. 3 shows a perspective view of an embodiment of the attachable tilling device, wherein one or more flap members are secured to the base member.

FIG. 4 shows a perspective view of an embodiment of the attachable tilling device secured to a tractor.

### DETAILED DESCRIPTION OF THE INVENTION

Reference is made herein to the attached drawings. Like reference numerals are used throughout the drawings to depict like or similar elements of the attachable tilling device. For the purposes of presenting a brief and clear description of the present invention, the preferred embodiment will be discussed as used for creating irrigation channels within the ground for uniformly distributing water to crops. The figures are intended for representative purposes only and should not be considered to be limiting in any respect.

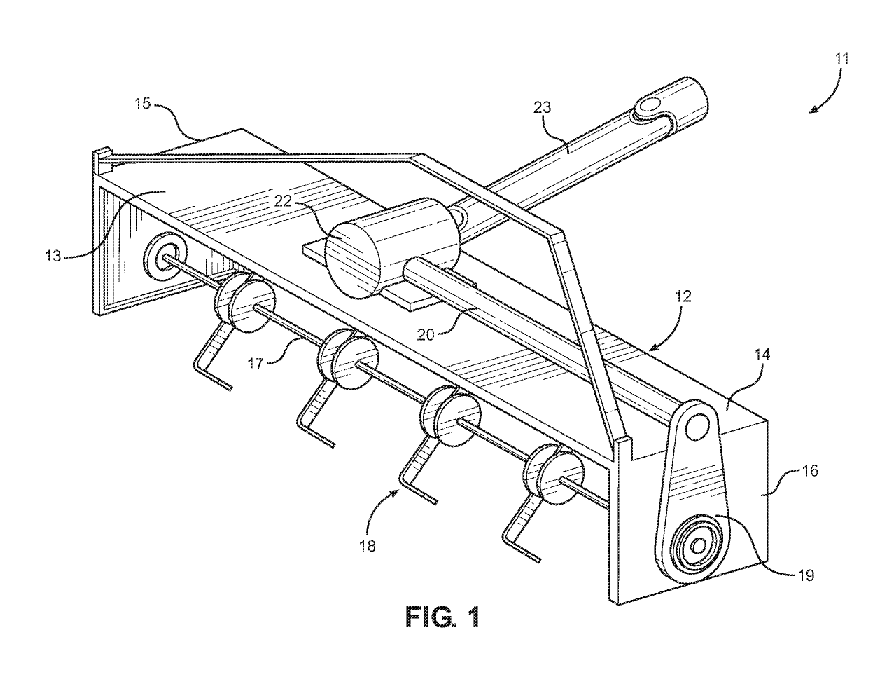

Referring now to FIG. 1, there is shown a perspective view of an embodiment of the attachable tilling device. The attachable tilling device 11 comprises a housing 12 having a base member 13 including a first end 14 and a second end 15, wherein a pair of opposing side members 16 extend downwardly from the first end 14 and the second end 15 of the base member 13. In the illustrated embodiment, the base member 13 and each of the pair of opposing side members 16 comprise a substantially rectangular shape. However, any suitable shape may be used. The housing 12 is constructed of a durable material, such as, steel. The durable material allows the housing 12 to maintain its structural integrity when being struck by dirt, rocks, and various debris during use.

The housing 12 includes a bar member 17 that is rotatably affixed between the pair of opposing side members 16. The bar member 17 is configured to rotate about a longitudinal axis thereof. The bar member 17 includes a plurality of tilling blades 18 affixed thereto. The plurality of tilling blades 18 are configured to create creases or channels within a ground for irrigation when the bar member 17 is rotated.

The housing 12 further includes a gear system 19 that is operably connected to the bar member 17, wherein the gear system 19 is configured to rotate the bar member 17. In the illustrated embodiment, the gear system 19 is disposed on a first opposing side member that extends from the first end 14 of the base member 12. However, any suitable arrangement may be used. A gearbox 22 is disposed on an upper side of the base member 13, wherein a pair of shaft members 20, 23 are operably connected to the gearbox 22, wherein a first shaft member 20 connects to the gear system 19 and a second shaft member 23 is configured to removably secure to a motor of a vehicle, such that when the motor is actuated, power is transferred from the motor to the gearbox 22, thereby rotating the plurality of tilling blades 18 disposed on the bar member 17. In this way, when the attachable tilling device 11 is removably secured to a vehicle, such as a tractor, the power from the tractor's engine is transferred to the gearbox 22 to actuate the rotation of the tilling blades 18.

In the illustrated embodiment, the first shaft member 20 is disposed on the upper side of the base member 13 in parallel with the longitudinal axis of the bar member 17, wherein each the first shaft member 20 and bar member 17 are rotatably attached to the gear system 19. The first shaft member 20 is configured to rotate the gear system 19, such that bar member 17 rotates. In the illustrated embodiment, the second shaft member 23 is disposed perpendicularly to the longitudinal axis of the base member 13, such that the second shaft member 23 can connect to the motor of the vehicle.

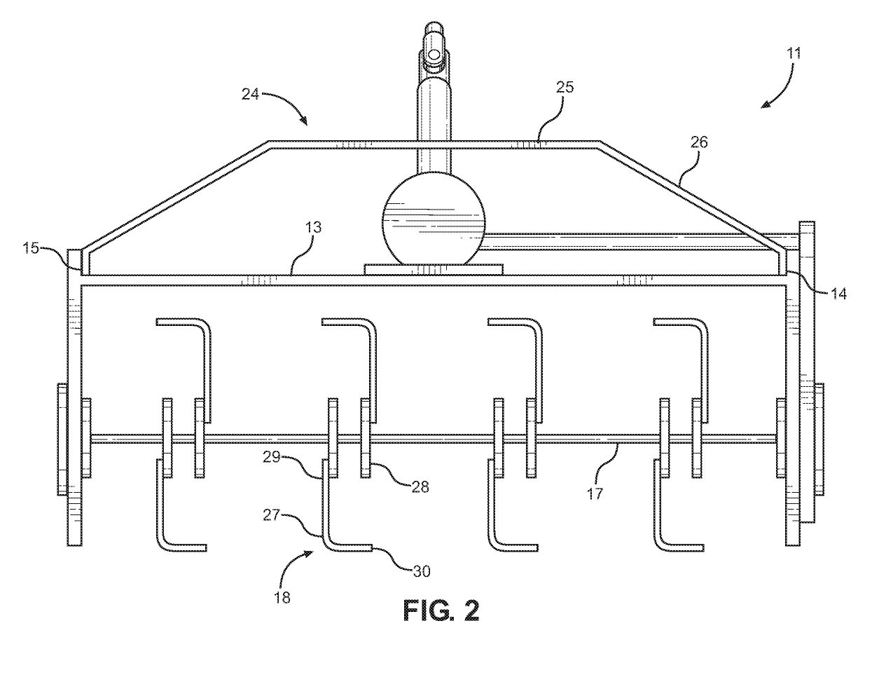

Referring now to FIG. 2, there is shown a front view of an embodiment of the attachable tilling device. In the illustrated embodiment, each tilling blade of the plurality of tilling blades 18 comprises a pair of opposing blades members 27 attached to a circular member 28, wherein the pair of opposing blades members 27 extend radially from the circular member 28. Each of the opposing blades members 27 includes proximal end 29 and a distal end 30, wherein the distal end 30 is disposed perpendicularly from the proximal end 29, such that each opposing blade member 27 comprises an L-shape. The L-shape blade configuration creates optimal irrigation channels, wherein little dirt or debris is left behind within the channel when in use.

In the illustrated embodiment, the plurality of tilling blades 18 comprises four tilling blades, wherein the four tilling blades are uniformly distributed along the length of the bar member 17. The four tilling blades excavate irrigation channels at predetermined intervals. The distance between each of the tilling blades provides irrigation channels that are separated, such that crops disposed between the irrigation channels are adequately spaced apart when fully grown.

In the illustrated embodiment, the housing of the attachable tilling device 11 further includes a support member 24 that is mounted to the upper side of the base member 13, wherein the support member 24 is configured to receive adjustable arms of a tractor. In the illustrated embodiment, the support member 24 comprises an elongated section 25 and a pair of opposing angled sections 26 that are affixed to the first end 14 and second end 15 of the base member 13. The support member 24 extends the length of the base member 13, such that the support bar 24 is configured to support the weight of the entire device 11. In this way, the support bar 24 allows a user to selectively raise or lower the attachable tilling device 11 in relation to the ground by receiving the adjustable arms of a tractor.

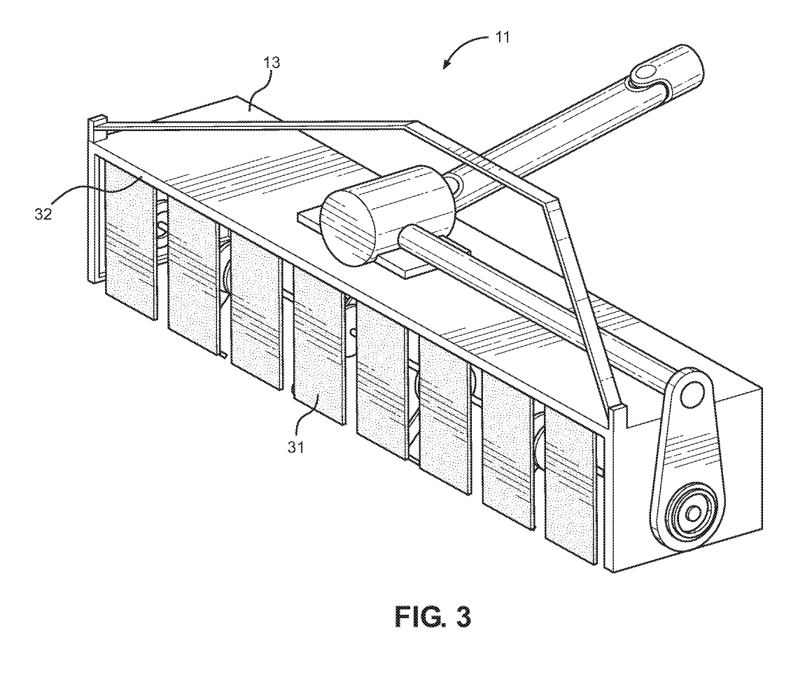

Referring now to FIG. 3, there is shown perspective view of an embodiment of the attachable tilling device, wherein one or more flap members are secured to the base member. In the illustrated embodiment, the base member 13 of the attachable tilling device 11 further includes one or more flap members 31 secured to each lateral side 32 of the base member 13. The flap members 31 are configured to prevent dirt from being projected outwardly form the housing of the device 12 when in use. In this way, a user is protected from being struck by a projectile when using the tilling device 11 to irrigate the ground.

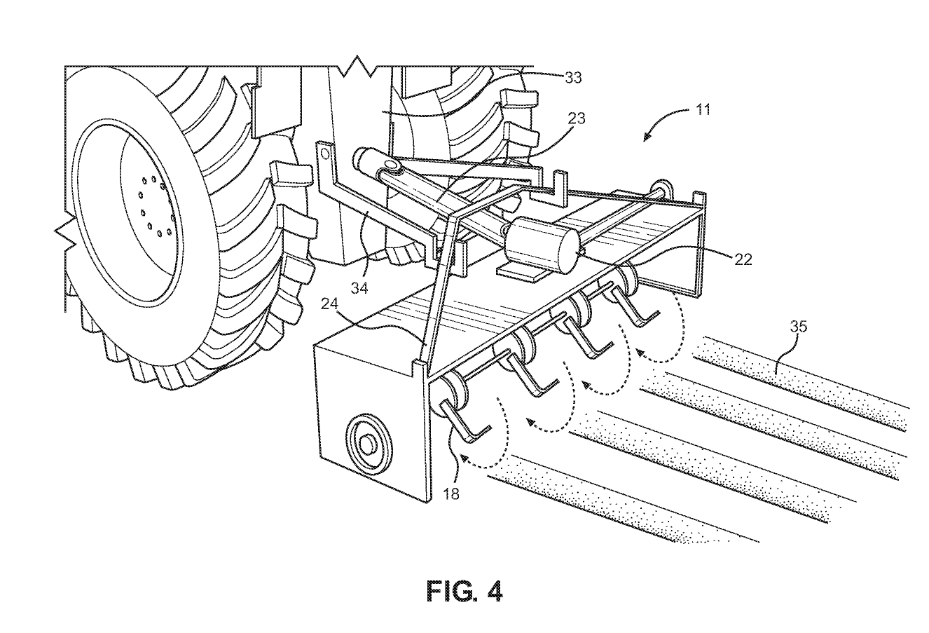

Referring now to FIG. 4, there is shown a perspective view of an embodiment of the attachable tilling device secured to a tractor. The attachable tilling device 11 is configured to removably secure to a rear end of a tractor 33. In the illustrated embodiment, the second shaft member 23 is rotatably attached to the tractor 33, such that the gearbox 22 is configured to transfer power from the motor of the tractor 33 thereby rotating the plurality of tilling blades 18. When the attachable tilling device 11 is positioned on the ground via the support member 24 and the adjustable arms 34 of the tractor 33, the rotating tilling blades 18 create irrigation channels 35 when pulled along the surface of the ground. The plurality of tilling blades 18 are configured to rotate, such that grass and dirt cut from the irrigation channel 35 is tossed toward the tractor, thereby preventing the grass and dirt from falling in the freshly excavated channel. In this way, the attachable tilling device 11 creates optimal irrigation channels for providing water to crops.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An attachable tilling device, comprising:
a housing having a base member including a first end and a second end, wherein a pair of opposing side members extend downwardly from the first end and the second end;
a bar member rotatably affixed between the pair of opposing side members, wherein the bar member is configured to rotate about a longitudinal axis thereof;
a plurality of tilling blades affixed to the bar member;
a gear system operably connected to the bar member, wherein the gear system is configured to rotate the bar member;
a gearbox disposed on an upper surface of the housing, wherein the gearbox is operably connected to a first shaft member and a second shaft member, wherein the first shaft member is operably connected to the gear system and the second shaft member is configured to operably connect to a motor of a vehicle.

2) The attachable tilling device of claim 1, wherein the base member includes one or more flap members extending downwardly from a lateral side thereof.

3) The attachable tilling device of claim 1, wherein each tilling blade of the plurality of tilling blades comprises a pair of opposing blade members attached to a circular member disposed on the bar member, wherein the pair of opposing blade members extend radially from the circular member.

4) The attachable tilling device of claim 3, wherein each of the opposing blade members of the pair of opposing blade members includes proximal end and a distal end, wherein the distal end is disposed perpendicularly from the proximal end.

5) The attachable tilling device of claim 1, wherein the plurality of tilling blades comprise four uniformly distributed tilling blades along a length of the bar member.

6) The attachable tilling device of claim 1, wherein the housing further comprises a support bar configured to receive adjustable support arms of a tractor, such that the attachable tilling device is configured to be raised upward and downward in relation to a ground.

7) The attachable tilling device of claim 1, wherein the housing is constructed of steel.

8) The attachable tilling device of claim 1, wherein the vehicle is a tractor.
